(19) United States
(12) Patent Application Publication
(10) Pub. No.: US 2014/0146157 A1
(43) Pub. Date: May 29, 2014

(54) SYSTEM AND METHOD FOR SAMPLE DILUTION AND PARTICLE IMAGING

(71) Applicant: FLUID IMAGING TECHNOLOGIES, INC., Yarmouth, ME (US)

(72) Inventors: Matthew Duplisea, Gorham, ME (US); Corie Drake, Portland, ME (US); Mason Ide, Gorham, ME (US)

(73) Assignee: FLUID IMAGING TECHNOLOGIES, INC., Yarmouth, ME (US)

(21) Appl. No.: 13/688,545

(22) Filed: Nov. 29, 2012

(51) Int. Cl. H04N 7/18

(52) U.S. Cl. CPC H04N 7/18
USPC 348/79

(57) ABSTRACT

A system for diluting a sample fluid sufficiently to enable the capture images of particles contained in the sample fluid. The system includes a fluid dilution system and a particle imaging system. The fluid dilution system includes a mixing conduit for combining a diluent and the sample solution. The mixing conduit is coupled to a flow chamber associated with imaging capturing devices including a camera. When the sample fluid is too opaque or viscous to enable capture of particle images of sufficient clarity, the fluid dilution system is activated to introduce diluent into the mixing conduit in sufficient volume to dilute the sample fluid. The diluted sample fluid is passed through the flow chamber and particle images captured. Information regarding captured images may be stored, analyzed and transferred from a remote location.

### FIELD OF THE INVENTION

The present invention relates generally to systems for analyzing fluids. More particularly, the present invention relates to systems and methods for modifying such fluids to enable the observation of the contents of the fluid, including obtaining images of particles within the fluid. Still more particularly, the present invention relates to fluid dilution systems and methods coupled with particle imaging activities.

### BACKGROUND OF THE INVENTION

Various optical/flow systems employed for transporting a fluid within an analytical instrument to an imaging and optical analysis area exist in the art. A liquid sample is typically delivered into the bore of a chamber and the sample is interrogated in some way so as to generate analytical information concerning the nature or properties of the sample. The sample may be stagnant or flowing. In one arrangement, a light source may be directed to the chamber to illuminate its contents. One or more photographs may be taken of the illuminated contents for the purpose of capturing one or more views of the contents of the fluid located in the photographic field. In another arrangement, a laser beam may excite the sample present in the chamber. Fluorescence energy emitted as a result of the excitation can provide signal information about the nature of the contents of the sample.

Obtaining images has been and remains a reasonable way to detect and observe the contents of samples, particularly fluid samples. It is desirable in doing so to avoid having too many particles in the photographic field so that the contents may be discerned in an effective manner. Fluids of interest vary widely in their viscosities and particle or solids density. Fluids with low levels of solids are more easily observed for content information than are fluids including high levels of solids. Nevertheless, there are fluids with high solids content for which analysis may be desired. For example, and without intending to be limiting, there is an interest in examining the contents of spent and cleaned drilling fluid, often referred to as drilling mud, removed from a well, to be reinserted into a well drilling process, or to be disposed of in a satisfactory manner.

It is possible to examine the contents of heavily loaded fluids through various observational and analytical tools. Unfortunately, these tools and these types of fluids require considerable time to condition the fluid sufficiently to get a reasonable portrayal of the contents and the evaluation process itself can be time consuming and relatively costly. In certain operating environments that time and expense may be acceptable, but in other operating environments, more time- and cost-efficient arrangements are desirable to provide information of importance regarding the contents of a fluid. Therefore, what is needed is a system and related method to enable the analysis of the contents of a fluid, particularly a fluid with high solids content. What is also needed is such a system and related method that provides an efficient and cost-effective way for conditioning the fluid to enable observation of particles contained within the fluid and then carrying out one or more steps to capture one or more images of those particles.

### SUMMARY OF THE INVENTION

It is an object of the present invention to provide a system and related method to enable the analysis of the contents of a fluid, particularly a fluid with high solids content. It is also an object of the present invention to provide a system and related method that provides an efficient and cost-effective way for conditioning the fluid to enable observation of particles contained within the fluid and then carrying out one or more steps to capture one or more images of those particles. These and other objects are achieved with the present invention, which includes a fluid dilution system and a particle imaging system that may be used in combination to reduce the solids content of a fluid under evaluation to a level sufficient to obtain reasonably clear pictures of one or more particles in the fluid.

The fluid dilution system of the invention includes a diluent supply, a sample supply, a container arranged to bring together the diluent and a fluid sample to be examined, a diluent delivery device, a sample delivery device and a computer device. The fluid dilution system is controllable by way of one or more sensors and the computer device to adjust flow rates of the diluent and sample and the delivery of the combined diluent and sample to the particle imaging system. The fluid dilution system regulates the extent of dilution of the fluid sample so that particles in the sample may be photographed.

The particle imaging system is coupled to the fluid dilution system. It receives the fluid sample, which may have been, but does not have to be diluted dependent on the clarity of particles contained in the sample. The particle imaging system includes a flow chamber configured to restrict the depth of field of the sample so that clear images may be captured. The particle imaging system includes lighting and photographic equipment described herein for the purpose of creating effective lighting and coordinated photograph taking. The FlowCam® fluid imaging system available from Fluid Imaging Technologies, Inc., of Yarmouth, Me., modified as described herein for joining with the fluid dilution system is suitable for capturing images in the diluent/sample fluid.

The flow chamber includes a channel arranged to transport the diluent/sample fluid therethrough at a selectable rate. The particle imaging system also includes a backlighting generator arranged to illuminate the fluid in the flow chamber, an objective arranged to receive incident optical radiation from the flow chamber, a light source arranged to generate light scatter from particles in the fluid, one or more detectors to detect light scatter caused by the particles upon illumination, a signal processor configured to receive signals from the one or more detectors and an image capturing system including means to capture images of particles in the fluid. The backlighting generator may be a light emitting diode flash. The backlighting generator generates a high intensity flash. The system also includes a computing device to receive signals from the image capturing system. The computer device may be the same computer device used to control fluid transfer through the fluid dilution system. The image capturing system includes a digital camera or an analog camera and a framegrabber. The image capturing system also includes a CCD or a CMOS camera.

The present invention is also an apparatus to assist in the imaging of particles in a fluid, the apparatus comprising a flow chamber including a channel arranged to transport the fluid therethrough at a selectable rate, wherein the fluid is transported using the fluid dilution system that moves the fluid through the chamber as well as enables the dilution of the sample under evaluation.

The present invention also provides a method for imaging particles in a fluid which is transported through a channel of a flow chamber at a selectable rate and illuminated with a light source so that scatter signals are detected. The method includes as primary steps the steps of acquiring one or more samples from a fluid prior to treatment, assessing the clarity of the sample for purposes of determining whether particle images may be captured, diluting the sample as needed based on the assessed clarity, passing the sample, which may be diluted, through the flow chamber, capturing images of particles in the sample, gathering data regarding characteristics of the particles, such as organisms, in the sample(s), storing that data and optionally analyzing the captured images.

The present invention enables the imaging of the contents of any fluid, regardless of its viscosity and/or clarity. These and other advantages of the present invention will become more readily apparent upon review of the following detailed description, the accompanying drawings, and the appended claims.

### BRIEF DESCRIPTION OF THE DRAWINGS

FIG. 1 is a front view of the system of the present invention for diluting a fluid and imaging the contents thereof.

FIG. 2 is a perspective view of the system shown in FIG. 1.

FIG. 3 is a simplified schematic representation of the particle imaging system of the present invention.

FIG. 4 is a diagram of the flow cell in one embodiment of the particle imaging system of the invention.

FIG. 5 is a flow diagram representing primary steps of the method of fluid dilution and particle image capturing of the present invention.

### DETAILED DESCRIPTION OF THE PREFERRED EMBODIMENT

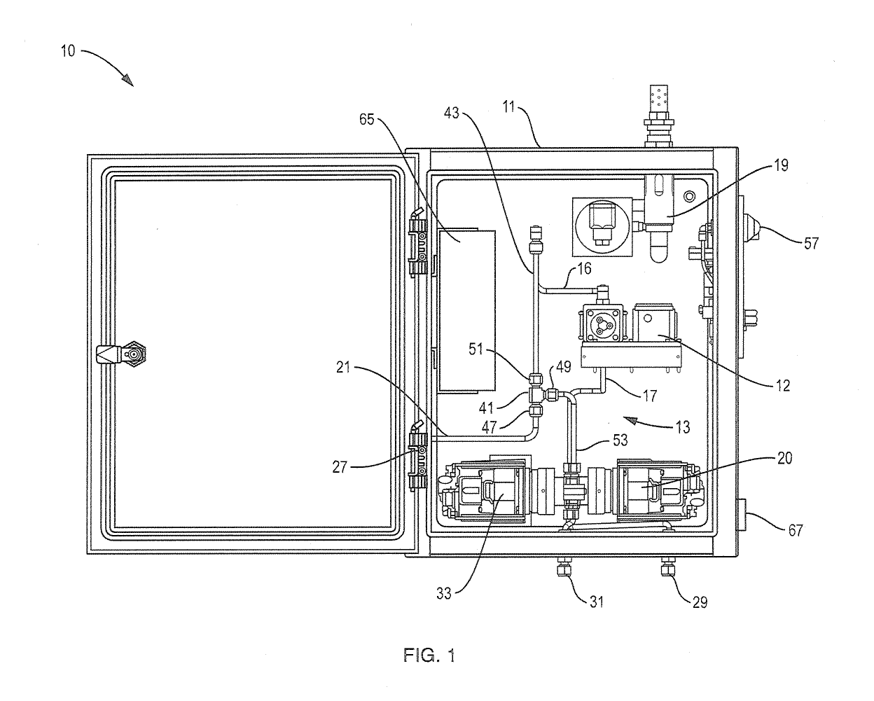

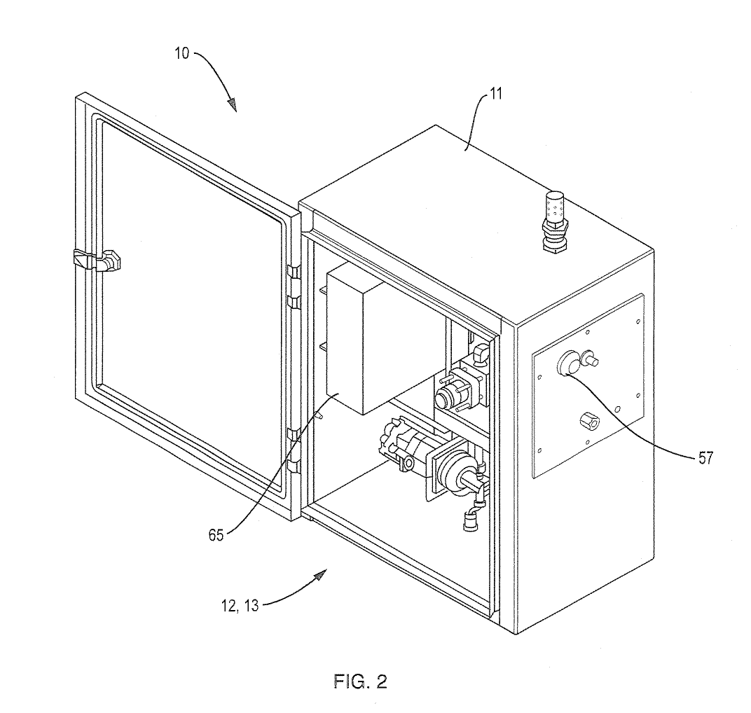

A system 10 of the present invention suitable for diluting a fluid, as necessary, and enabling the generation of high quality automated imaging of particles that exist in a fluid is shown in FIGS. 1 and 2. The system 10 includes an optional containment box 11, a fluid dilution system 13, a particle imaging system 12, an optional cooling element 19 and a computing device 65. The containment box may be weather tight so that the system 10 may be deployed to a remote location for automated sample, for example, wherein data are collected and either processed onsite and the results transmitted to a different location, or the data may be transmitted to a different location for processing. The computing device 65 forms part of the fluid dilution system 13 and the particle imaging system 12 and may be embodied in a single computing device as represented herein or as two separate computing device, one for each of systems 13 and 12, wherein the two computing devices in that embodiment are in signal exchange communication with one another.

The dilution system 13 includes a diluent conduit 21, a diluent pump 20, a sample inlet 31, a sample pump 33, a mixing interface 41 and a mixing conduit 43. The diluent conduit 21, which may be a pipe or tube, for example, includes a diluent inlet 27 that may be coupled to a diluent source (not shown). The diluent source may be any sort of container arranged for retaining therein a fluid diluent of choice including, but not limited to, water. The diluent inlet 27 of the diluent inlet 21 may also be coupled to a continuous source of fluid diluent, such as a tap of a public water supply, for example. The fluid diluent is transferred through operation of the diluent pump 20, which draws the fluid diluent from the diluent conduit 21 and transfers it through the mixing interface 41 and the mixing conduit 43 before its entry with the sample to be evaluated into the particle imaging system 12. The sample diluted by the diluent, if dilution occurs, passes out of the particle imaging system 12 through imaging outlet conduit 17 and the containment box 11 through a waste outlet 29. The waste outlet 29 may be coupled to additional piping (not shown) for proper treatment, if needed, and delivery to an ultimate outlet.

The sample inlet 31 may be coupled to a source (not shown) of a fluid to be evaluated for particle content. The sample source may be any sort of container arranged for retaining therein a sample fluid of interest. The container may be a syringe, for example, but not limited thereto. The fluid sample is transferred to the mixing interface 41 through operation of the sample pump 33, which draws the sample from the sample inlet 31.

The mixing interface 41 may be a mixing valve or other type of multi-way exchange component. The mixing interface 41 includes a first inlet 47, a second inlet 49 and an outlet 52. The first inlet 47 is coupled to the diluent conduit 21, the second inlet 49 is coupled to a sample conduit 53 that is coupled to the sample pump 33, and the outlet 52 is coupled to the mixing conduit 43. The diluent and the sample are first joined together at the mixing interface 41 and pass through the mixing conduit 43 before entering the particle imaging system 12 through imaging inlet conduit 16. The mixing interface 41 may be a pipe or tube and may include a static mixing structure therein to enhance the mixing of the diluent and sample together prior to entering the particle imaging system 12. The mixing interface 41 may also include a dynamic mixer.

The containment box 11 may include a purge port 57 for exhausting gases that may build up within the box 11 in the course of analyzing the sample. Such build up may occur as a result of operation of the components of the system and any cooling agent that may be exhausted by the cooler 19. The purge port 57 may be coupled with a Mimi-Z9Y) purge unit available from Expo Technologies, inc., of Twinsburg, Ohio. The cooler 19 should be sufficiently robust to remain operable in harsh environments. A device that uses compressed air to produce a jet of cold air or a thermoelectric device can perform that function. The AVC-000-003 cabinet cooler available from Expo Technologies, inc., of Twinsburg, Ohio, is suitable for that purpose. The diluent pump 20 and the sample pump 33 may be arranged with stepper motors and controlled with stepper controllers managed by the computing device 65. The diluent pump 20 may be a Model STRH precision adjustment stepper miniature OEM pump available from Fluid Metering, Inc., of Syosset, N.Y. The sample pump 33 may also be a Model STRH precision adjustment stepper miniature OEM pump available from Fluid Metering, Inc., of Syosset, N.Y. The conduits may be formed of any one or more of several nonmetallic materials including, but not limited to, polypropylene. Alternatively, one or more metallic materials may be used including, but not limited to, stainless steel, or any other material capable of transporting the fluids to be inspected. The system 10 may include one or more sensors for sensing conditions inside and outside the containment box 11 and that information used in performing the steps described herein and may include one or more sensors for sensing temperature and/or pressure within and outside the containment box 11 as well as any location of interest associated with the fluid dilution system 13, the particle imaging system 12 and the optional cooling element 19. One or more fluid position sensors, such as optical sensors, are used to sense fluid location in the conduits and that information transferred for use in controlling the functioning of the pumps. The OCB350L250Z fluid position sensor from OPTEK Electronics of Carrollton, Tex., is a suitable optical sensor for that purpose.

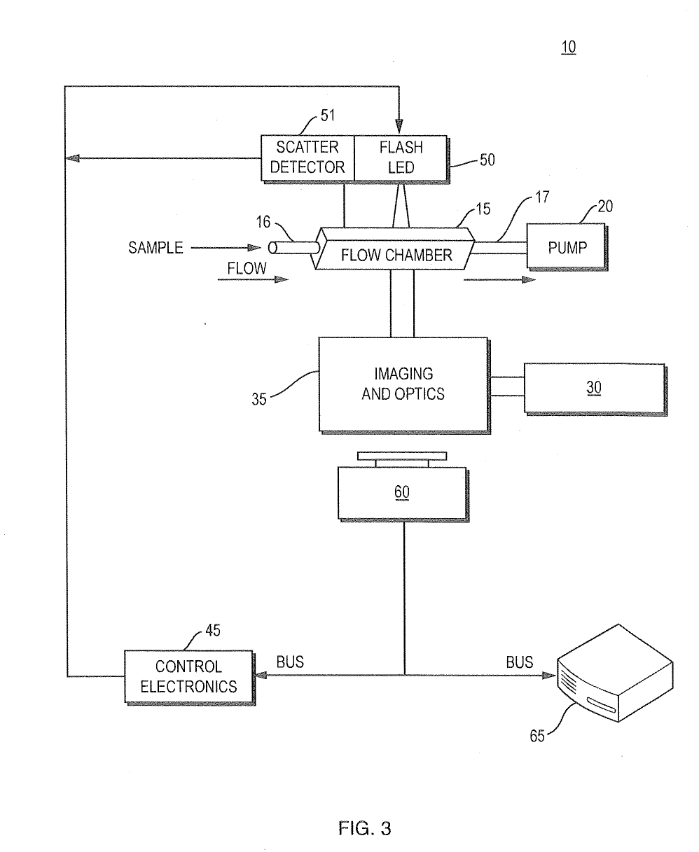

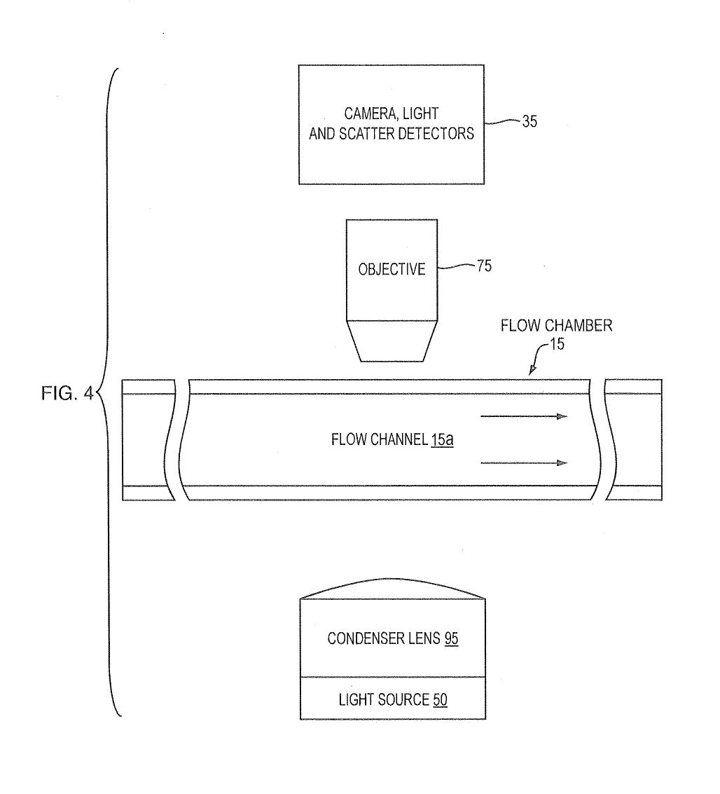

With reference to FIGS. 3 and 4, the particle imaging system 12 includes a flow chamber 15 coupled to inlet conduit 16 and outlet conduit 17, a light source 30, an imaging and optics system 35, an image detection system 40 including control electronics 45, a backlighting generator 50, an image capturing system 60 and the computing device 65. The combination of these components of the system 10 arranged and configured as described herein enable a user to detect particles in the diluted sample and, specifically, to enhance the accuracy and sensitivity of such detection.

The flow chamber 15 includes an inlet for receiving the particle-containing sample to be evaluated and an outlet through which the sample passes out of the flow chamber 15 after imaging functions have been performed. The flow chamber 15 may be fabricated of a material suitable for image capturing, including, for example, but not limited to, transparent microscope glass or glass extrusions that may be ruggedized to withstand abrasive materials. The flow chamber 15 may be formed in a rectangular shape as shown or it may be U-shaped. The flow chamber 15 may be circular or rectangular in shape. The flow chamber 15 defines a channel 15a through which the fluid flows at a predetermined selectable rate determined by operation of the diluent pump 20. The channel 15a may be of rectangular configuration. The length and width of channel 15a are selected to roughly match the field of view of the imaging optics 35 and may further be sized as a function of the particular fluid to be analyzed and the desire to avoid clogging. The flow chamber 15 may have the channel 15a about 0.6 millimeters deep when the sample fluid is drilling mud, for example. The particle imaging system 12 may include the use of multiple ones of the flow chamber 15, which may be substituted, sued in series or used in parallel. The inlet of the flow chamber 15 is connectable to the inlet conduit 16 and the outlet is connectable to the outlet conduit 17.

The light source 30 is used to generate scatter excitation light which is passed through the optics and imaging system 35 to the flow chamber 15, resulting in light scatter by particles located in the fluid. The light source 30 may be a high-powered LED. The imaging and optics system 35 includes a microscope objective 75 to image the particle flow onto the image capturing system 60 and focus excitation light from the light source 30 onto the flow chamber 15. The control electronics 45 may be configured to receive input signals and produce output information compatible with the specific needs of the user of the system 10. An example of a suitable electronics system capable of performing the signal activation and output information associated with the control electronics 45 of the system 10 is the detection electronics described in U.S. Pat. No. 6,115,119, the entire content of which is incorporated herein by reference. Those of ordinary skill in the art will recognize that the specific electronics system described therein may be modified, such as through suitable programming for example, to trigger desired signal activation and/or to manipulate received signals for desired output information.

The light source 30 may be operated to transmit light periodically, sporadically, or regularly. For example, the light source may emit light signals and a scatter detector 51 may be employed on the back side of the flow chamber 15 to detect changes in light signals from the light source, such as when a particle passes through the flow chamber 15. The scatter detector 51 may be any type of suitable device capable of detecting variations in received light and transmitting electrical signals indicative of the light variations. In one embodiment, the scatter detector 51 may be an array of photoreceptive sensors. The scatter detector 51 is coupled to the control electronics 45 to signal to the control electronics the light change indicative of the existence of a particle in the flow chamber 15. The control electronics 45 is coupled to the computing device 65. The computing device 65 is programmed to store the information received from the control electronics 45 and to make calculations and processing decisions based on the information received. The computing device 65 may also be a data collector that transmits the collected data to a different computing component for processing at that component. The computing device 65 is also configured to transmit operational instructions to the pumps 20 and 33 as well as other devices of the system 10. The computing device 65 may be any sort of computing system suitable for receiving information, running software programs on its one or more processors, and producing output of information, including, but not limited to images and data, that may be observed on a user interface. The computing device 65 may be embodied in one device, as shown in FIGS. 1 and 2; it may comprise a plurality of components that are connected by wire or wirelessly to one another. The computing device 65 may also gather data and transmit that data from a remote location to a location that processes the data. The computing device 65 may be managed remotely or locally. For example, the computing device 65 may be configured with a transmission/reception capability, such as through wireless signal exchanges established at wireless transceiver interface 67 shown in FIG. 1, for data and device management signal exchanges. The signal exchange arrangement may be used to schedule the undertaking of sample fluid analyses and dilution activities. It may also be used to incorporate the system 10 into a bigger processing system.

The control electronics 45 is also coupled, directly or indirectly through the computing device 65 to the backlighting generator 50, which may include a condenser lens 95. In particular, the control electronics 45 and the computing device 65 are arranged to generate a trigger signal to activate the backlighting generator 50 to emit a light flash upon detection of a particle or particles in the flow chamber 15. That is, the trigger signal generated produces a signal to activate the operation of the backlighting generator 50 so that a light flash is generated. Specifically, the backlighting generator 50 may be a Light Emitting Diode (LED) flash or other suitable light generating means that produces a light of sufficient intensity to backlight the flow chamber 15 and image the passing particles. The LED flash may be a 670 nm LED flash, or a flash of another other suitable wavelength of high intensity, which is flashed on one side of the flow chamber 15 for 200 μsec (or less). At the same time, the image capturing system 60 positioned on the opposing side of the flow chamber 15 is activated to capture an instantaneous image of the particles in the fluid suspended in a fixed position when the strobe effect of the high intensity flash occurs. One or more mirrors may be employed to divert light if it is determined that the backlighting is too intensive for effective image capture. The high NA condenser lens 95 aids in clear illumination of that section of the fluid in the flow channel 15a that is to be imaged by focusing the high intensity flash from the backlighting generator 50 to that section. The high NA condenser lens 95 includes characteristics of a numerical aperture of about 1.25 and may be the AA2354932 1.25NA Abbe condenser available from Motic Incorporation Ltd. of Hong Kong.

The image capturing system 60 is arranged to either retain the captured image, transfer it to the computing device 65, or a combination of the two. The image capturing system 60 includes characteristics of a digital camera or an analog camera with a framegrabber or other means for retaining images. For example, but in no way limiting what this particular component of the system may be, the image capturing system 60 may be, but is not limited to being, a CCD firewire, a CCD USB-based camera, or other suitable device that can be used to capture images and that further preferably includes computing means or means that may be coupled to computing means for the purpose of retaining images and to manipulate those images as desired. The computing device 65 may be programmed to measure the size and shape of the particle captured by the image capturing system 60 and/or store the data for later analysis.

The images captured by the image capturing system 60 and stored with the computing device 65 may be analyzed and compared to known images of particles including, for example, Zebra Mussels. When a trigger is generated (i.e., a light scattering particle is detected), software scans the resulting image, separating the different particle sub-images in it. The area of each particle may be measured by summing the number of pixels in each particle image below a selectable threshold and multiplying the result by the equivalent physical area of a pixel. This computed area of the particle is stored in a spreadsheet-compatible file along with other properties of the particle, e.g., time of particle passage and the location of the particle in the image. The sub-image of each particle is copied from the chamber image and saved with other sub-images in a collage file. Several of these collage files may be generated for each system experiment. A special system file is generated, containing the collage file location of each particle sub-image, particle size and time of particle passage.

The software is written to generate two data review modes: (1) image collage and (2) interactive scattergram. In the image collage mode, the user may review a series of selectable sub-images in a collage file. Reviewing these files allows the user to identify particle types, count particles, or study other features. In interactive scattergram mode, data is presented to the user as a dot-plot; e.g., a graph of particle size. If the user selects a region of the scattergram, images of particles having the characteristics plotted in that region are displayed on a display of the computing device 65, allowing the user to study particle populations and to examine images of particles with specific sizes, such as cells of a specific type. Because a spreadsheet compatible file is generated for each review, the user may also review the data with a spreadsheet program. This information allows the user to readily generate cell counts and scatter and size distribution histograms for each sample. This file also contains the location of each particle in the original image which is used to remove redundant data from particles that have become attached to the flow chamber 15.

The system 10 further optionally includes one or more additional pumps that transport a plurality of sample fluids and/or diluents dependent on the existence of sample fluid sources and/or the desired diluent to use. The multiple inputs may be manifolded and fluid and diluent selection may be made through controls established through the computing device 65.

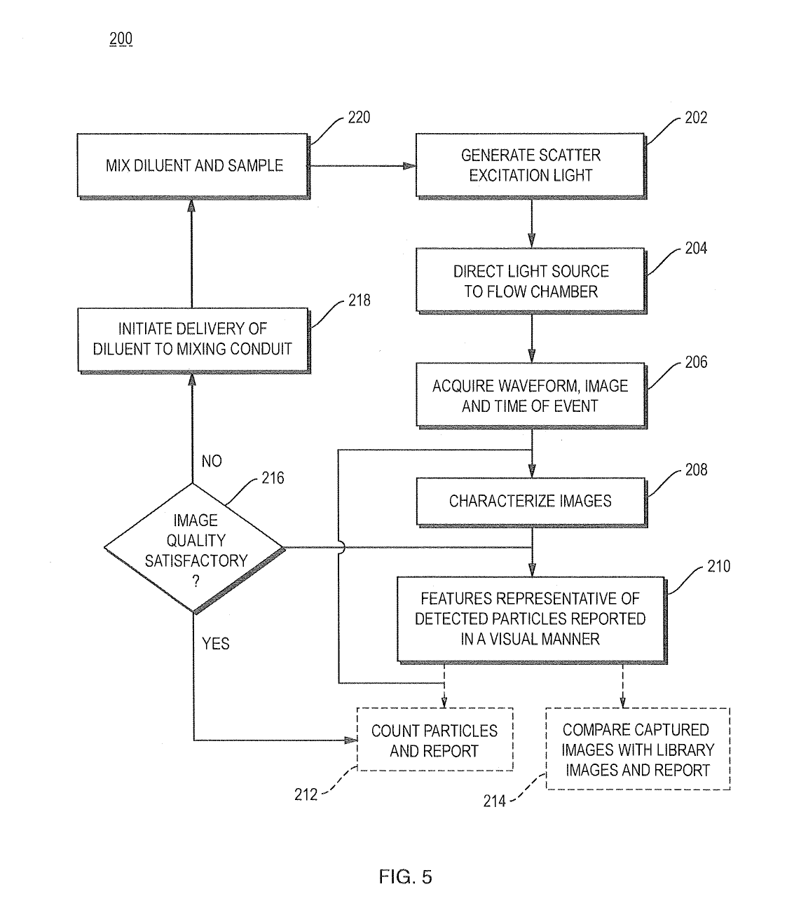

As represented in FIG. 5, a method 200 of the present invention embodied in one or more computer programs, includes steps associated with storing and analyzing images captured with the system 10 of the present invention. In the first step, step 202, the light source 30 and imaging optics 35 generate scatter excitation light, which is directed to the flow chamber 15 within which a fluid to be monitored passes, step 204. The particle imaging system 12 including the control electronics 45 is used to detect separately, images associated with the light waveforms scattered from particles in the flow chamber 15. The detected images are transferred to the computing device 65 for storage and analysis, step 206. The images captured are characterized based on particle shape and size, in addition to other information of interest, step 208. Features representative of the particles in the fluid may be detected and that information may be reported in a visual manner, step 210. For example, the information may be presented in graphic representations, spreadsheet lists, or combinations thereof. Optionally, the acquired image information may be used to count the number of particles in the fluid sample observed and reported, step 212, and/or the captured images may be compared to known images of particles of interest and reported, step 214.

With continuing reference to FIG. 5, at one or more places along the way of acquiring the images and processing them, the gathered data are analyzed to determine whether the particle images are of sufficient quality, such as within a specified size range, for example, for effective analysis, step 216. For example, if the particles cannot be sufficiently identified by size or type, or it is not possible to acquire any images at all, then the analysis process is re-initiated. If the data gathered are insufficient to characterize the particles, then the fluid dilution system 13 is activated, such as by transmission of a signal to the controller of the stepper motor of the diluent pump 20, to initiate delivery of the diluent to the mixing interface 41, step 218. That activation causes the diluent to mix with the sample in the mixing conduit 43, step 220, and at least steps 202, 204 and 206 are repeated. The analysis process is also repeated to determine whether the dilution was sufficient to enable satisfactory particle image capture. The dilution process may be repeated as often as necessary until such time as satisfactory data are acquired. The amount of diluent directed to the mixing interface 41 is selectable and controlled through the computing device 65 to regulate the stepper motor associated with the diluent pump 20. Experimentation may be required to establish a suitable dilution range for a particular sample. That information may then be input to the computing device 65 for the purpose of establishing operational parameters for the pumps. In some situations, the sample may not require any dilution, in which case no diluent is delivered by the diluent pump 20. In those situations, the diluent pump 20 can be placed in an intermediate closed position or a secondary valve may be used to close off the diluent flow path. Other options of operation to regulate the use or non-use of diluent may be employed, such as taking the diluent pump 20 completely offline.

As noted, it is to be understood that the computing device 65 used to gather the captured image information and to perform calculations and observe features of the captured image information may be associated with local or remote computing means, such as one or more central computers, in a local area network, a metropolitan area network, a wide area network, or through intranet and internet connections. The computing device 65 may include one or more discrete computer processor devices. The computing device may include computer devices operated by a centralized administrative entity or by a plurality of users located at one or more locations.

The computing device 65 may be programmed to include one or more of the functions of the system 10. The computing device 65 may include one or more databases including information related to the use of the system 10. For example, such a database may include known images of example particles of interest. The database may be populated and updated with information provided by the user and others.

The steps of the method 200 described herein and additional steps not specifically described with respect to FIG. 5 but related to the use of the system 10 may be carried out as electronic functions performed through the computing device 65 based on computer programming steps. The functions configured to perform the steps described herein may be implemented in hardware and/or software. For example, particular software, firmware, or microcode functions executing on the computing device 65 can provide the trigger, image capturing and image analysis functions. Alternatively, or in addition, hardware modules, such as programmable arrays, can be used in the devices to provide some or all of those functions, provided they are programmed to perform the steps described.

The steps of the method 200 of the present invention, individually or in combination, may be implemented as a computer program product tangibly as computer-readable signals on a computer-readable medium, for example, a non-volatile recording medium, an integrated circuit memory element, or a combination thereof. Such computer program product may include computer-readable signals tangibly embodied on the computer-readable medium, where such signals define instructions, for example, as part of one or more programs that, as a result of being executed by a computer, instruct the computer to perform one or more processes or acts described herein, and/or various examples, variations and combinations thereof. Such instructions may be written in any of a plurality of programming languages, for example, C++ or any of a variety of combinations thereof. The computer-readable medium on which such instructions are stored may reside on one or more of the components of system 10 described above and may be distributed across one or more such components. Further, the steps of the method represented in FIG. 5 may be performed in alternative orders, in parallel and serially without deviating from the invention.

The system 10 of the present invention allows much greater flexibility in carrying out analyses of fluids. The system 10 may be used to identify particles in a highly viscous fluid, in a fluid with a significant solids content or a combination of the two. For example and not limited thereto, the system 10 may be used to identify particles in drilling mud, which has a high solids content and is often too opaque to acquire any information about individual particles therein. In that situation, the fluid dilution system 13 may be activated to dilute a drilling mud sample fluid to such a level that individual particles may be identified and characterized, such as by number, in a given volume of fluid. The capability of the system is not limited thereto.

One or more embodiments of the invention have been described. Nevertheless, it will be understood that various modifications may be made without departing from the spirit and scope of the invention as described by the following claims. All equivalents are deemed to be within the scope of the claims.

What is claimed is:

1. A system for imaging particles in a fluid, the system comprising:
a. a fluid dilution system, the fluid dilution system including:
i. a mixing interface configured to receive a diluent and a sample fluid to be analyzed;
ii. a mixing conduit coupled to the mixing interface to transport a mixture of the diluent and the sample fluid therein; and
iii. a diluent pump arranged to cause movement of the diluent and the sample fluid into the mixing conduit;
b. a particle imaging system, the particle imaging system including:
i. a flow chamber coupled to the mixing conduit and arranged to transport the mixture therethrough;
ii. a light source arranged to generate scatter excitation light to illuminate particles in the mixture in the flow chamber;
iii. a backlighting generator arranged to produce a light of sufficient intensity to backlight the flow chamber;
iv. a microscope objective arranged to focus light from the light source onto the flow chamber;
v. a scatter detector to detect changes in the light from the light source indicative of the existence of one or more particles in the flow chamber;
vi. control electronics configured to receive signals from the scatter detector, wherein the control electronics are coupled to the backlighting generator and configured to activate the operation of the backlighting generator;
vii. an image capturing system including means to capture images of particles in the fluid; and
c. a computing device to receive signals from the control electronics and the image capturing system, to control operation of the diluent pump and to output information about particles detected in the mixture.

2. The system of claim 1 wherein the means to capture images of particles includes a digital or analog camera and a framegrabber.

3. The system of claim 1 wherein the backlighting generator is arranged to generate a high intensity flash.

4. The system of claim 3 wherein the backlighting generator is a light emitting diode flash.

5. The system of claim 1 wherein the computing device includes means to store data and images associated with detected particles and software to generate with the computing device particle data as image collages and interactive scattergrams.

6. The system of claim 1 wherein the mixing conduit includes a static mixer or a dynamic mixer.

7. The system of claim 1 wherein the computing device includes a wireless transceiver for sending data and receiving commands to and from a remote location.

8. The system of claim 1 further comprising a containment box for retaining therein the fluid dilution system, the particle imaging system and the computing device.

9. The system of claim 8 wherein the containment box is weatherproof.

10. The system of claim 1 wherein the mixing interface is a mixing valve.

10. A method for diluting a sample fluid and imaging particles in the sample fluid, the method comprising the steps of:
a. transporting the sample fluid through a channel of a flow chamber at a selectable rate;
b. generating scatter excitation light to illuminate the fluid in the flow chamber;
c. detecting scattered light signals indicative of the existence of one or more particles in the flow chamber;
d. backlighting the flow chamber upon detection of scattered light signals;
e. capturing images of particles within the flow chamber;
f. acquiring information about the particles associated with the clarity of the images;
g. initiating dilution of the sample fluid by mixing a diluent with the sample fluid;
h. repeating steps a.-f.; and
i. repeating steps g. and h. only if the particle images are of insufficient clarity.

11. The method of claim 10 wherein the step of capturing images of particles involves the use of a digital or analog camera and a framegrabber.

12. The method of claim 10 wherein the step of backlighting the flow chamber is achieved using a backlighting generator arranged to generate a high intensity flash.

13. The method of claim 12 wherein the backlighting generator is a light emitting diode flash.

14. The method of claim 10 further comprising the steps of storing data and images associated with detected particles and generating particle data as image collages and interactive scattergrams.

15. The method of claim 10 wherein no dilution step is initiated.

16. The method of claim 10 wherein the volume of diluent mixed with the sample fluid is selectable.
